(19) United States
(12) Patent Application Publication
(10) Pub. No.: US 2003/0163634 A1
(43) Pub. Date: Aug. 28, 2003

(54) Portable data storage apparatus

(76) Inventor: Jung-ryul Kim, Kangjin-ku (KR)

Correspondence Address: Douglas B McKnight, Calfee Halter & Griswold, 800 Superior Avenue, Suite 1400, Cleveland, OH, 44114-2688, US

(21) Appl. No.: 10/240,236

(22) PCT Filed: Mar. 23, 2001
(86) PCT No.: PCT/KR01/00474

(30) Foreign Application Priority Data
Mar. 30, 2000 (KR) 2000/16534

(51) Int. Cl. G06F 12/00

(52) U.S. Cl. 711/103; 711/104

(57) ABSTRACT

This invention relates to a portable data storage apparatus being capable of storing data in the form of compressed image. The stored data can be automatically recovered as necessary. The portable data storage apparatus comprises EPROMs, an operating system control unit, a CPU for controlling the operation of the apparatus associated with EPROMs and the operating system control unit, a flash memory unit having a plurality of flash memories, a connector for providing serial, parallel or USB interface, and a data communication control unit.

### TECHNICAL FIELD

The present invention relates to a portable data storage device. In particular, the present invention relates to the portable data storage device which compresses data from an information providing terminal, makes a backup of the compressed data, and stores the compressed data. The compressed data in the portable data storage device may be decompressed automatically and used as necessary.

### BACKGROUND ART

The conventional computer system stores and makes a backup of data using not only the main storage device but also the indelible storage device (e.g., hard disk, magnetic tape, optic disk, etc.) which does not lose data even when there is no power supply.

However, the hard disk is expensive and hard to carry. The optic disk such as CD-ROM (Read Only Memory) has slower access speed because it uses the direct access method. Moreover, the optic disk has another drawback in that once data are stored in the optic disk, it is difficult to erase such data and store new data in the disk.

In order to resolve the above-mentioned problems, portable data storage devices, such as CD-RW (Re-Writable) or ZIP drive, have been developed and used.

While it is possible to write and erase data many times in the CD-RW, the CD-RW is not compatible with various devices. Furthermore, the data stored in the CD-RW may not be read through the conventional CD-ROM drive or CD recorder.

The ZIP drive is superior to CD-RW in the stability and compatibility. However, the ZIP drive also has not completely resolved all the problems describe above.

In summary, the conventional data storage device such as hard disks, magnetic tapes or optic disks are inconvenient to use because such devices cannot operate by themselves and because it is hard to carry them. Additionally, portable data storage devices such as CD-RWs or ZIP drives have low compatibility or storage capacity and fail to overcome the inconvenience in carrying the devices due to the large size of the devices.

### DISCLOSURE OF INVENTION

In order to resolve the above-described problems with the conventional data storage devices, the present invention provides the new portable data storage device which may store a large amount of data in a small data storage device and may easily be carried.

Thus, the present invention provides the portable data storage device which compresses data into image form, makes a backup of such compressed data, stores them, and restores the original data by automatically decompressing the data as necessary to use the data.

More specifically, the present invention provides the portable data storage device comprising: an EPROM which stores the software and driver information related to the operation of the data storage device; an operating system control unit containing the operating system for the data compression, backup and storing; a central processing unit which performs the image compression of the data, backup and storage function of the compressed data while associated with the operating system control unit and the EPROM; a flash memory unit which contains a plurality of flash memories and stores the image data compressed by the central processing unit; a connector for providing serial, parallel or USB interface for the data communication with various external information devices; and a data communication control unit for transmitting and receiving data to and from the external information devices which are connected through the connector.

The central processing Unit, which generally controls and processes the overall operation with a Rambus DRAM or controller, compresses the data transmitted from external information devices into image data, makes a backup of such data and stores the compressed data in the flash memory unit.

### BRIEF DESCRIPTION OF DRAWINGS

FIG. 1 is a block diagram illustrating the structure of the portable data storage device according to the present invention.

FIG. 2 is a flow chart illustrating the data processing operation of the portable data storage device according to the present invention.

### BEST MODE FOR CARRYING OUT THE INVENTION

Reference will now be made in detail to the preferred implementation of the present invention as illustrated in the accompanying drawings.

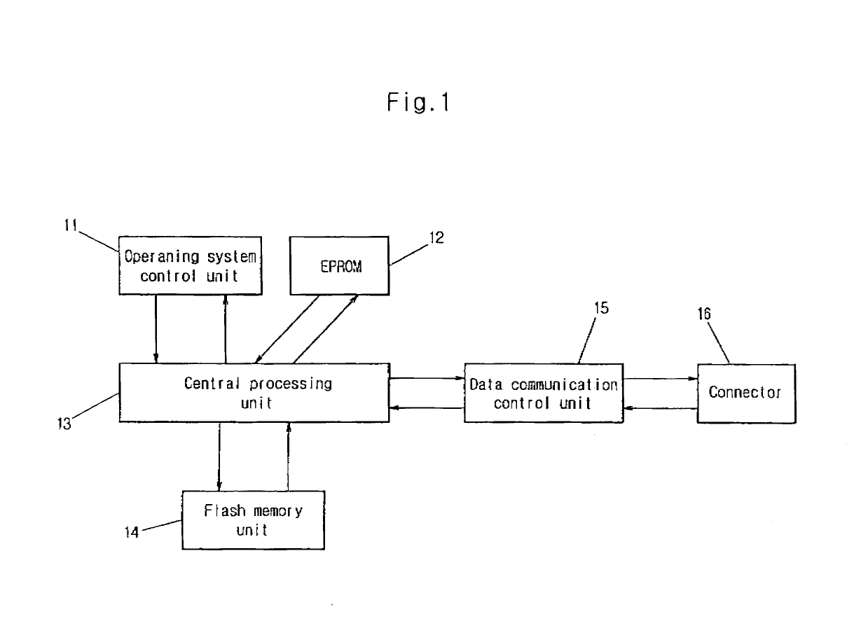

As illustrated in FIG. 1, the portable data storage device comprises the operating system control unit (11), the EPROM (Erasable and Programmable Read Only Memory, 12), the central processing unit (13), the flash memory unit (14), the data communication control unit (15) and the connector (16).

The operating system control unit (11), which contains the operating system for the compression, backup and storage of the data, controls all the operations of the data storage device such as the input and output control, interruption processing, memory allotment, operating time planning, message exchange and telecommunication functions, while associated with the central processing unit (13).

The EPROM (12) stores the software and driver information related to the operations of the data storage device. The central processing unit (13), in connection with the operating system control unit (11) and the EPROM (12), compresses the data into image form such as Norton ghost and backups and stores such compressed data. The central processing unit (13) can control and process the overall operations because it contains a Rambus DRAM (Dynamnic Random Access Memory) or a controller.

The flash memory unit (14), composed of multiple flash memories, stores the image form data compressed by the central processing unit (13). The data communication control unit (15) transmits and receives data by communicating with an external information device (e.g., a mobile phone, computer or PDA) which is connected through the connector (16) supporting the serial, parallel or USB (Universal Serial Bus) interface. The connector (16) supports the serial, parallel or USB interface for the data transmission and reception to and from the external information device.

Through the portable data storage device comprised according to the present invention, which compresses the data transmitted from an external information device into image form and makes the backup of and stores such data in the flash memory, data may be conveniently stored and it is possible to minimize the size of the device.

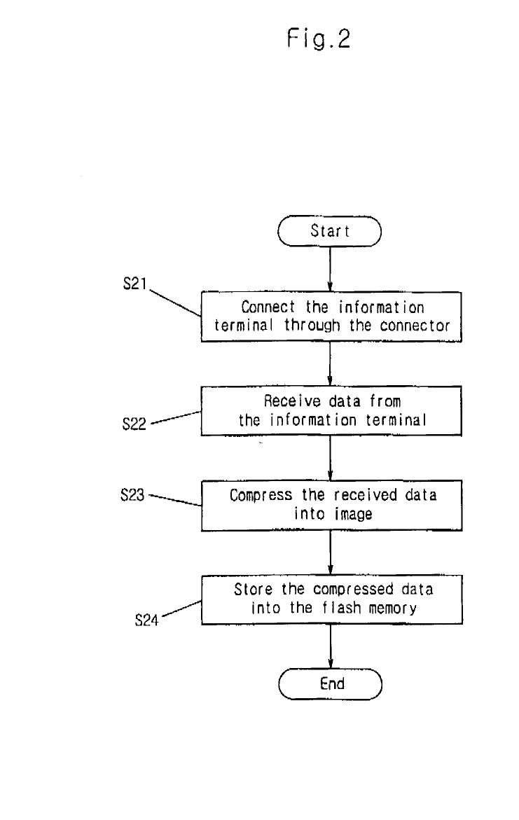

The data processing operations of the portable data storage device are explained with reference to FIG. 2.

The connector (16) of the portable data storage device is connected to the information device (Step S21). The connector (16) has ports supporting the serial, parallel or USB interface.

The central processing unit (13) loads and runs the operating system stored in the operating system control unit (11). It also accesses the operation software and operation driver stored in the EPROM (12) and executes the operation software and operation driver in the data communication control unit (15).

The data communication control unit (15) receives from the information device the data to be backed-up or stored and transmits the data to the central processing unit (13) (Step S22).

The central processing unit (13) makes the backup of or stores the received data in a flash memory of the flash memory unit (14). Specifically, in association with the operating system control unit (11), the central processing unit (13) compresses the to received data into the image form (e.g., Norton ghost image) (Step S23) and makes the backup of or stores the compressed data in a flash memory of the flash memory unit (14) (Step S24). The data of 100Mbyte are preferably compressed into the data of approximately 1Mbyte in the present invention.

As explained above, in the portable data storage device according to the present invention, data are backed-up or stored in the image form. Thus, a great amount of data may be stored into a small volume of flash memories. Accordingly, the device may be made small in size and thus it may be convenient to carry and use such device.

The compressed data in the image form stored in the flash memory unit may be automatically decompressed and thus the original data may be recovered through the computer system with an image compression program.

The present invention's device may be very useful in cases where it is necessary to make the backup of the data stored in a portable information device such as a mobile phone, where the backup of data is required for the business purpose, where it is desired to store and move the data in order to use the data in a different place or where it is necessary to download and store certain information available on the Internet from an information device connected to the Internet.

The preferred embodiment of the present invention is not limited to what is described in this document. Rather, various alternatives, modifications or changes may be made to the described example of the present invention within the limit apparent to the ordinary person skilled in the relevant art in connection with the present invention.

What is claimed is:

1. A portable data storage device comprising:
an EPROM which stores the software and driver information related to the operation of the data storage device;
an operating system control unit which contains an operating system for the compression, backup and storage of data;
a central processing unit which, in association with said operating system control unit and said EPROM, compresses the data into the image form and makes the backup of or stores the compressed data;
a flash memory unit which, composed of multiple flash memories, stores the data compressed into the image form by said central processing unit;
a connector which supports the serial, parallel or USB interface for the data communication with an external information device; and
a data communication control unit which transmits and receives data to and from said external information device connected through said connector.

2. The portable data storage device according to claim 1, wherein the central processing unit contains a Rambus DRAM or a controller and, thus, controls the overall operations of the data storage device.
